(19) United States
(12) Patent Application Publication
(10) Pub. No.: US 2008/0024018 A1
(43) Pub. Date: Jan. 31, 2008

(54) Rotor for an electric rotary machine, and a method of manufacture

(75) Inventors: Robert Rignault, Balzac (FR); Sebastien Porcher, Saint Palais de Blaye (FR)

Correspondence Address: OLIFF & BERRIDGE, PLC, P.O. BOX 320850, ALEXANDRIA, VA, 22320-4850, US

(73) Assignee: MOTEURS LEROY-SOMER, ANGOULEME (FR)

(21) Appl. No.: 11/822,953

(22) Filed: Jul. 11, 2007

(30) Foreign Application Priority Data
Jul. 13, 2006 (FR) 06 52988

(51) Int. Cl. H02K 15/03; H02K 1/22; H02K 1/27; H02K 1/28

(52) U.S. Cl. 310/42; 29/598; 310/156.38; 310/156.59; 310/43; 310/58

(57) ABSTRACT

The present invention relates to a rotor for an electric rotary machine, the rotor comprising a hub having pole pieces placed thereon, and wherein: the pole pieces include a molded portion fitting closely around at least a portion of the shape of the hub and/or, the hub includes a molded portion fitting closely around at least a portion of the shape of the pole pieces, the hub including a reinforcement supporting the molded portion and/or the molded portion including reinforcing fibers or particles.

The present invention relates to rotary electric machines, and more particularly to the rotors of such machines.

### BACKGROUND

Patent EP 1 249 919 B1 discloses a flux-concentrating rotor comprising pole pieces disposed between permanent magnets and held by a hub via dovetail connections.

The pole pieces are positioned by accurate machining of the hub. Such machining presents the drawback of being relatively expensive, and the invention seeks to simplify manufacture of the rotor. In a variant, the hub is made by injection of a material in contact with the pole pieces which are made separately.

### SUMMARY

The invention provides a rotor for an electric rotary machine, the rotor comprising a hub having pole pieces placed thereon.

In one of the aspects of the invention, the pole pieces include a molded portion fitting closely around at least a portion of the hub.

In another aspect of the invention, may can be combined with the precedent, the hub includes a molded portion fitting closely around at least a portion of the pole pieces, the hub including a reinforcement supporting the molded portion and/or the molded portion including reinforcing fibers or particles.

Exemplary embodiment of the invention offer the advantage that the pole pieces may be more easily positioned correctly relative to the axis of rotation of the machine. For example, accurate machining of the hub may not be necessary, since the molded portion may serve to hold the pole pieces accurately relative to the axis of rotation of the machine.

In an embodiment of the invention, the hub has a molded portion fitting closely around at least part of the shape of the pole pieces. The hub may include reinforcement supporting the molded portion, said reinforcement possibly being made of metal, e.g. being extruded or molded. Under such circumstances, the reinforcement does not need prior machining. In a variant, the reinforcement may comprise reinforced synthetic material.

The molded portion is advantageously made of non-magnetic material.

One of the hub and the pole pieces may include a first portion in relief, and the other of the hub and the pole pieces may include a second portion in relief co-operating with the first portion in relief to retain the pole pieces on the hub against the action of centrifugal force.

One of the first and second portions in relief may include a spline having a cross-section of dovetail shape and the other may include a groove of shape suitable for receiving the spline.

One of the first and second portions in relief may be formed at least in part with the reinforcement, and a gap may be left between the reinforcement and the pole pieces for receiving the molded portion.

The reinforcement may be made integrally with a shaft of the rotor, or in a variant it may be fitted on a shaft of the rotor.

The reinforcement and the pole pieces may come into contact, or they may be spaced apart by the molded portion.

The molded portion may comprise a thermoplastic material or a polymerized resin, in which case it may include a filler of reinforcing fibers or particles, where appropriate. The use of a nonmetal material to make the molded portion facilitates the implementation of the invention and the temperature of injection may be lower.

The molded portion may also comprise a metal material.

The molded portion may extend axially beyond the pole pieces and/or the hub, e.g. to form at least one cheekplate for axially holding the pole pieces and/or the permanent magnets placed between the pole pieces.

The molded portion may also form at least one portion in relief contributing to ventilating the machine, and/or to providing a cheekplate for dynamic balancing of the rotor.

The magnets may present a cross-section of thickness that is not constant, e.g. being generally trapezoidal in shape or lozenge-shaped.

The pole pieces may comprise stacks of superposed magnetic laminations. In a variant, the pole pieces may be molded in contact with the hub and may include a filler of particles presenting non-zero magnetic susceptibility.

In another of its aspects, the invention also provides a method of manufacturing a rotor for a rotary electric machine, the rotor comprising a hub and pole pieces disposed on the hub, in which method:
at least a portion of the pole pieces is molded in contact with the hub or a part having the same shape and/or,
at least a portion of the hub is molded in contact with the pole pieces or a part having the same shape, the molded portion including reinforcing fibers or particles and/or the hub including a reinforcement supporting the molded portion. The reinforcement is, for example, made of metal and the molded portion comprises a nonmetal material.

The pole pieces may be positioned for molding relative to the axis of rotation of the machine in contact with a positioning tool that is disposed radially outside them.

Magnets may be inserted between the pole pieces prior to molding.

The magnets may be blocked between the pole pieces by centrifuging or by applying mechanical thrust, prior to molding taking place.

At least one of a cheekplate for axially maintaining the pole pieces and/or the magnets, a cheekplate for dynamic balancing, and a member for cooling the machine may be molded together with the above-mentioned portion.

Molding may be performed in a mold that contains the rotor.

The hub may include metal reinforcement with the molding being performed in contact therewith. In a variant, during molding, the reinforcement may be replaced by a part that has the same shape, and after unmolding, the reinforcement is inserted into the gap thus made available, with insertion being performed by force, for example.

The molding may be performed by injecting a thermoplastic material or by casting a polymerizable resin.

### BRIEF DESCRIPTION OF THE DRAWINGS

The invention can be better understood on reading the following detailed description of non-limiting embodiments thereof, and on examining the accompanying drawings, in which:

FIG. 1 is a diagrammatic side view of a rotor made in accordance with the invention;

FIG. 2 is a diagrammatic cross-section of the rotor on II-II of FIG. 1;

FIG. 3 shows detail III of FIG. 2;

FIGS. 4 to 7 are views analogous to FIG. 3 showing variant embodiments; and

FIG. 8 is a view analogous to FIG. 2 showing a fragment of another variant embodiment.

### MORE DETAILED DESCRIPTION

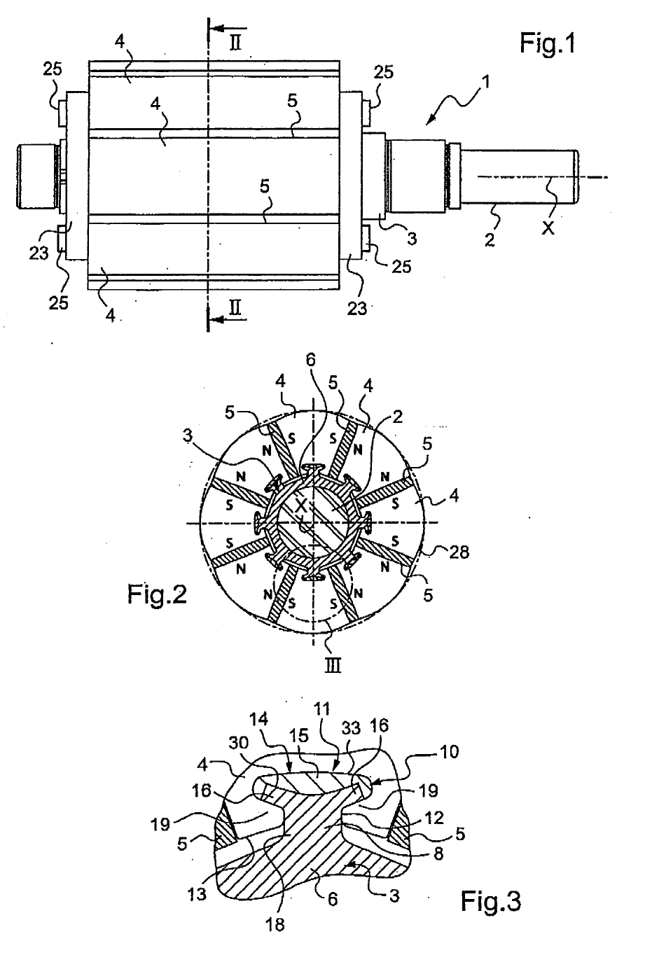

The rotor 1 shown in FIG. 1 comprises a shaft 2 of longitudinal axis X having mounted thereon a hub 3 that carries a plurality of pole pieces 4 between which permanent magnets 5 are disposed. The hub 3 and the shaft 2 may be made of a non-magnetic material.

Each pole piece 4 serves to concentrate the magnetic flux from the adjacent magnets 5, both of which present faces of the same N or S polarity facing the pole piece 4, as shown in FIG. 2.

In the example described, the hub 3 is fitted onto the shaft 2, however in a variant that is not shown, the hub 3 could be made integrally with the shaft.

By way of example, the pole pieces 4 are made up of stacks of superposed magnetic laminations and in the example shown they are secured to the hub by co-operating shapes between first portions in relief 10 that project from the hub 3, and second portions in relief 11 that are recessed in the pole pieces 4.

In the example shown, the first portions in relief 10 are formed by dovetail-shaped splines, and the second portions in relief are formed by grooves of complementary shape, each opening out through an opening 12 in the radially-inner surface 13 of the corresponding pole piece. These grooves may be made by cutting the laminations making up the pole pieces.

In the example described, the hub 3 comprises firstly reinforcement 6, e.g. made of metal or of a reinforced synthetic material, and secondly a molded portion 15 in contact with the reinforcement 6.

More precisely, the reinforcement 6 in the example shown is made with projecting shapes 8 that constitute the structural portions of the first portions in relief 10, each of these projecting shapes comprising a trunk 18 connected to an annular portion 7 of the reinforcement 6, and extensions 16 extending laterally on either side of the trunk 18, as can be seen in particular in FIG. 3.

The molded portion 15 extends in the space 14 formed between the reinforcement 6 and the pole pieces 4, and in the example described it occupies all of this space. The presence of the molded portion 15 serves to block the pole pieces 4 in predefined positions relative to the axis of rotation of the machine.

Each opening 12 in the pole pieces 4 in the example described is constituted by setbacks 19 that are spaced apart at a distance corresponding substantially to the width of the corresponding trunk 18. These setbacks 19 enable the first portions in relief 10 to take up the centrifugal forces acting on the pole pieces 4.

By way of example, the molded portion 15 is made of synthetic material that is injected or cast during manufacture of the rotor into the space 14, as described in detail below.

The molded portion 15 may extend axially beyond the space 14 so as to form cheekplates 23 disposed axially on either side of the pole pieces 4 and the magnets 5, as can be seen in FIG. 1.

By way of example, the cheekplates 23 can serve to hold the pole pieces 4 and the magnets 5 axially and they can also serve, where appropriate, as cheekplates for dynamic balancing since they can receive one or more rotor-balancing weights or they can have material removed appropriately for balancing the rotor.

The cheekplates 23 may also have portions in relief 25 serving to cool the machine, such as fins, for example.

Where appropriate, the molded portion 15 may be made of metal, in particular a non-magnetic metal such as aluminum or a non-magnetic alloy.

In the example described, each magnet 5 presents, in cross-section, a shape that is generally lozenge-shaped, having thickness that passes through an extremum substantially halfway across.

The radially-outer surface 28 of each pole piece 4 may be circularly cylindrical, not centered on the axis X, but having a radius of curvature that is smaller than the envelope radius of the rotor, as shown in the figure.

In the example of FIG. 3, the projecting shape 8 of the reinforcement 6 constituting the structural portion of the first portions in relief 10 presents a radially-outer face 30 that is outwardly concave.

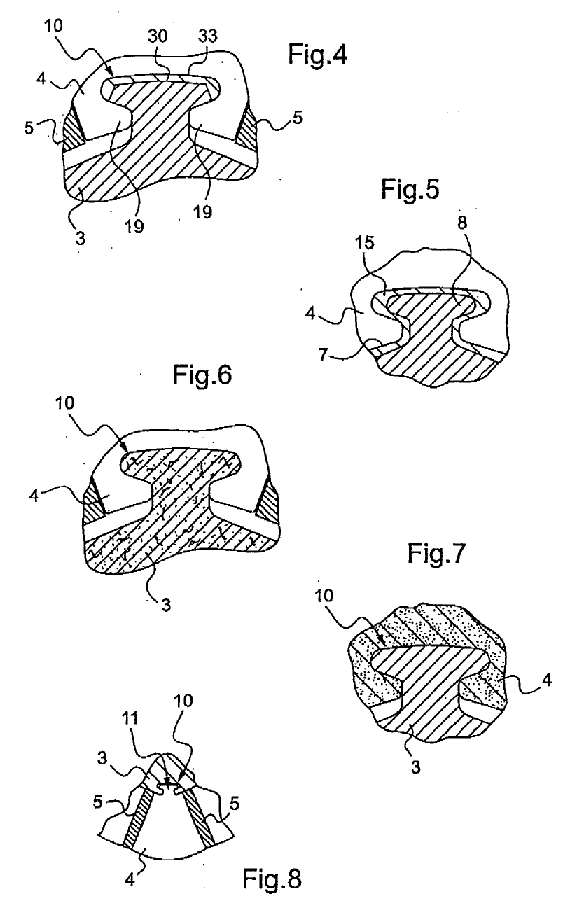

In the variant shown in FIG. 4, this face 30 is slightly convex so as to match the shape of the bottom 33 of the groove constituting the corresponding second portion in relief.

In the variant shown in FIG. 5, the structural portion 8 extends over its entire periphery at a distance from the corresponding pole piece 4, and the portion 15 completely covers the structural portion 8 and possibly also the annular portion 7 of the reinforcement 6 of the hub 3.

In the variant shown in FIG. 6, the hub 3 is made entirely by molding, of a synthetic material and includes reinforcing fibers or particles.

By way of example, in the variant shown in FIG. 7, the hub 3 is made entirely out of metal, e.g. by extrusion, and the pole pieces 4 are molded for example in contact with the hub or in contact with a part having the same shape, out of a synthetic material including a filler of particles presenting non-zero magnetic susceptibility, e.g. iron particles.

Naturally, the invention is not limited to portions in relief projecting from the hub and having recesses in the pole pieces.

By way of example, FIG. 8 shows a rotor having pole pieces 4 presenting projecting second portions in relief 11 engaged in recessed first portions in relief 10 implemented in the hub 3, which may optionally include reinforcement 6.

To manufacture a rotor in accordance with any of the above examples, at least a portion of the hub is cast in contact with the pole pieces or with a part having the same shape, or in a variant, at least one portion of the pole pieces is molded in contact with the hub or with a part having the same shape.

When at least a portion of the hub is molded in contact with the pole pieces, they need to be positioned relative to the axis of rotation of the machine before performing the molding operation.

When the hub includes reinforcement 6, e.g. metal reinforcement made by extrusion, it can be positioned inside the pole pieces and then a filler material can be injected or cast so as to make the molded portion of the hub. In a variant, a part having the same shape as the reinforcement may be used for molding purposes.

The positioning of the pole pieces relative to the axis of rotation of the machine can be performed, for example, by means of a positioning tool, e.g. located radially outside the pole pieces, e.g. a tool that is generally cylindrical in shape with its radially-inside surface presenting a succession of lobes for matching the shape of the radially-outer surfaces of the pole pieces 4. In a variant, the positioning tool may comprise, for example, fingers engaged in holes in the pole pieces. Positioning can be performed in other ways as well.

The magnets 5 may be put into place between the pole pieces 4 before the filler material is injected or cast, and prior to molding the magnets 5 may be held in position by being jammed between the pole pieces 4, e.g. by centrifuging the rotor or by applying mechanical thrust.

Once the filler material has solidified or polymerized, the rotor can be unmolded, and where appropriate centrifuged again in order to increase the clamping of the magnets between the pole pieces 4.

The shaft 2 may optionally be present inside the pole pieces 4 while the filler material is being injected or cast. Where appropriate, the shaft may be made as a single piece together with the hub, by injecting or casting the filler material.

When the pole pieces 4 are molded in contact with the hub 3, or in contact with a part having the same shape, that part or piece may be put into position in a mold of appropriate shape and the filler material may be injected or cast therearound. The permanent magnets may be placed inside the mold during injection or casting of the filler material or subsequently, in gaps left between the pole pieces by the shapes of the mold or by using parts provided for this purpose.

In yet another variant, the hub is made at least in part by molding, as are the pole pieces.

Where appropriate, the filler material is injected or cast into a mold enabling at least one cooling portion in relief of the machine to be made and/or at least one end cheekplate that extends axially beyond the hub, and/or the pole pieces and/or the permanent magnets, as mentioned above.

The invention is not limited to the examples described above, and the characteristics of the various examples may, in particular, be combined within variants that are not shown.

The magnets may be of some other shape, for example of trapezoidal shape, as described in patent EP 1 249 919 B1.

The pole pieces may also present some other shape.

The first and second portions in relief may be made with shapes other than those shown.

The molded portion need not project axially beyond the hub or the pole pieces, with them being held axially by using fitted cheekplates, which can then be made out of a material other than the filler material.

When at least one fitted cheekplate is used, the fitted cheekplate(s) may be held pressed against the pole pieces by means of ties passing through the pole pieces via holes made therein. Where appropriate, the ties can be made by the operation of casting the filler material.

The invention is applicable to an inner rotor, an outer rotor, or to an axial magnetic flux rotor.

The term “comprising a” should be understood as being synonymous with “comprising at least one”.

What is claimed is:

1. A rotor for an electric rotary machine, the rotor comprising a hub having pole pieces placed thereon, and wherein:
the pole pieces include a molded portion fitting closely around at least a portion of the shape of the hub and/or,
the hub includes a molded portion fitting closely around at least a portion of the shape of the pole pieces, the hub including a reinforcement supporting the molded portion and/or the molded portion including reinforcing fibers or particles.

2. A rotor according to claim 1, the pole pieces including a molded portion fitting closely around at least a portion of the shape of the hub.

3. A rotor according to claim 1, the hub including a molded portion fitting closely around at least a portion of the shape of the pole pieces and a reinforcement supporting the molded portion.

4. A rotor according to claim 1, the hub including a molded portion fitting closely around at least a portion of the shape of the pole pieces, the molded portion including reinforcing fibers or particles.

5. A rotor according to claim 1, in which the reinforcement is made of metal.

6. A rotor according to claim 5, in which the reinforcement is made by extrusion or by molding.

7. A rotor according to claim 1, in which the reinforcement comprises reinforced synthetic material.

8. A rotor according to claim 1, in which the molded portion is made of a non-magnetic material.

9. A rotor according to claim 1, in which one of the hub and the pole pieces includes a first portion in relief and the other of the hub and the pole pieces includes a second portion in relief co-operating with the first portion in relief to retain the pole pieces on the hub against the action of centrifugal force.

10. A rotor according to claim 9, in which one of the first and second portions in relief comprises a spline of dovetail shape in cross-section, and the other comprises a groove of a shape suitable for receiving the spline.

11. A rotor according to claim 10, in which the hub includes reinforcement supporting the molded portion, and in which one of the first and second portions in relief is formed at least in part together with the reinforcement.

12. A rotor according to claim 11, in which a gap is left between the reinforcement and the pole pieces in order to receive the molded portion.

13. A rotor according to claim 3, in which the reinforcement is made integrally with a shaft of the rotor.

14. A rotor according to claim 3, in which the reinforcement is fitted on a shaft of the rotor.

15. A rotor according to claim 5, in which the reinforcement and the pole pieces come into contact.

16. A rotor according to claim 5, in which the reinforcement and the pole pieces are separated by the molded portion.

17. A rotor according to claim 1, in which the molded portion comprises a thermoplastic material.

18. A rotor according to claim 1, in which the molded portion comprises a polymerized resin.

19. A rotor according to claim 1, in which the molded portion comprises a metal material.

20. A rotor according to claim 17, in which the molded portion includes a filler of reinforcing fibers or particles.

21. A rotor according to claim 1, in which the molded portion extends axially beyond the pole pieces and/or the hub.

22. A rotor according to claim 1, in which the molded portion forms at least one cheekplate for axially holding the pole pieces.

23. A rotor according to claim 1, including permanent magnets disposed between the pole pieces.

24. A rotor according to claim 23, in which the molded portion forms at least one cheekplate for axially holding the magnets.

25. A rotor according to claim 1, in which the molded portion forms at least one portion in relief contributing to ventilating the machine.

26. A rotor according to claim 1, in which the molded portion forms at least one cheekplate for dynamic balancing of the rotor.

27. A rotor according to claim 23, in which the magnets present a cross-section of non-constant thickness.

28. A rotor according to claim 27, in which the magnets present a section of substantially trapezoidal shape.

29. A rotor according to claim 27, in which the magnets present a section of substantially lozenge-shaped.

30. A rotor according to claim 1, in which the pole pieces comprise stacks of superposed magnetic laminations.

31. A rotor according to claim 1, in which the pole pieces are molded in contact with the hub and include a filler of particles having non-zero magnetic susceptibility.

32. A rotor according to claim 1, including at least one cheekplate fitted against the pole pieces and held against the pole pieces by means of ties passing through the pole pieces via holes made therethrough.

33. A rotor according to claim 32, in which the ties are created during the operation of molding the molded portion.

34. A method of manufacturing a rotor for a rotary electric machine, the rotor comprising a hub and pole pieces disposed on the hub, in which method:
at least a portion of the pole pieces is molded in contact with the hub or a part having the same shape and/or,
at least a portion of the hub is molded in contact with the pole pieces or a part having the same shape, the molded portion including reinforcing fibers or particles and/or the hub including a reinforcement supporting the molded portion.

35. A method according to claim 34, in which the pole pieces are positioned for molding relative to the axis of rotation of the machine in contact with a positioning tool disposed radially outside them.

36. A method according to claim 34, in which the magnets are introduced between the pole pieces prior to molding.

37. A method according to claim 36, in which the magnets are blocked between the pole pieces by centrifuging or by applying mechanical thrust prior to the molding being performed.

38. A method according to claim 34, in which at least one of a cheekplate for axially holding the pole pieces and/or the magnets, a cheekplate for dynamic balancing, and a cooling member of the machine is molded together with said portion.

39. A method according to claim 34, in which the molding is performed in a mold in which the rotor is contained.

40. A method according to claim 34, in which the hub includes reinforcement in contact with which the molding is performed.

41. A method according to claim 34, in which the molding is performed by injecting a thermoplastic material.

42. A method according to claim 34, in which the molding is performed by casting a polymerizable resin.
